(19) United States
(12) Patent Application Publication
(10) Pub. No.: US 2023/0281615 A1
(43) Pub. Date: Sep. 7, 2023

(54) SYSTEMS AND METHODS FOR USER IDENTIFICATION

(71) Applicants: Kashish Soien, Gurugram (IN); Rajat Tripathi, Gurugram (IN)

(72) Inventors: Kashish Soien, Gurugram (IN); Rajat Tripathi, Gurugram (IN)

(21) Appl. No.: 17/686,762

(22) Filed: Mar. 4, 2022

(51) Int. Cl. G06Q 20/38; G06Q 20/40

(52) U.S. Cl. CPC G06Q 20/385; G06Q 20/40

(57) ABSTRACT

Pursuant to some embodiments, systems, methods and computer program code are provided for processing an input data set to create a final data set in which a unique identifier is assigned to each set of transactions that can be linked to a user.

### BACKGROUND

Consumers interact with merchants and other service providers remotely using different user identifiers. In many situations, a consumer is not identified by a single identifier to tie the different user identifiers together. For example, a consumer may interact with one merchant using a first credit card, email, and phone number, and may interact with a different merchant using a second credit card, a different email address and the same phone number. A payment service provider that services both merchants may then have two different sets of identifying data associated with the same customer. Things get even more complex as family members share a credit card but use different phone numbers and email addresses. Complexity is also introduced when consumers use phones that have multiple phone numbers associated therewith (e.g., such as when a consumer uses dual subscriber identification modules or “SIMS”). That consumer may be associated with transactions in which either phone number is used. Other identifiers may also be associated with the consumer, such as an address, an Internet Protocol (“IP”) address, a cardholder name, etc.

It would be desirable to provide systems and methods to uniquely identify users even where such disparate transaction data is available. It would further be desirable to allow the accuracy of the identification to be varied based on one or more defining parameters.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating an identification processing system pursuant to some embodiments.

FIG. 2 is a diagram illustrating a method pursuant to some embodiments.

FIG. 3 illustrates portions of input and intermediate data tables pursuant to some embodiments.

FIG. 4 is a diagram illustrating a method pursuant to some embodiments.

FIG. 5 is a diagram illustrating a table of preference rules pursuant to some embodiments.

FIG. 6 illustrates portions of intermediate data tables pursuant to some embodiments.

FIG. 7 is a diagram illustrating a computing system for use in the examples herein in accordance with some embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Pursuant to some embodiments, systems, methods, processes and computer program code are provided for processing an input data set to create a final data set in which a unique identifier (“UID”) is assigned to each set of transactions that can be linked to a user. Embodiments allow the efficient identification and assignment of UIDs to transaction data sets using a number of different identifiers contained in the data sets.

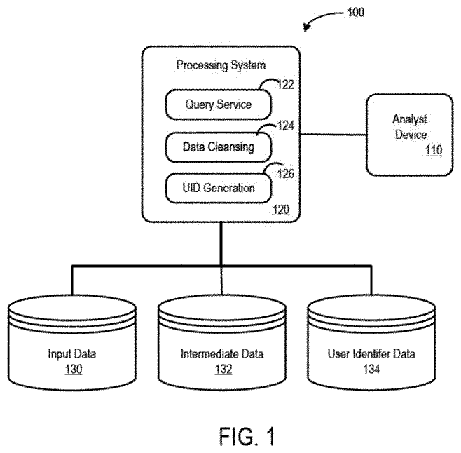

Features of some embodiments will be described by first referring to FIG. 1 which depicts a system 100 pursuant to some embodiments of the present invention. As shown, the system 100 includes a processing system 120 in communication with an analyst device 110 (operated by an analyst, not shown in FIG. 1) to interact with one or more applications 122-126 operated by or under control of the processing system 120. As used herein, the term analyst is used to refer to an operator or user or software application that interacts with the processing system 120 to perform processing as described herein. The term “analyst” is used to avoid confusion with the term “user” (which is used herein to refer to individuals associated with transactions to be analyzed as described further below) and is not intended to imply that the operator of device 110 have any particular analytical skills (as none may be needed to interact with the system 120).

The processing system 120 may be operated by or on behalf of an entity that wishes to allow authorized analysts to interact with a large set of transaction data to, for example, generate a customer centric set of data in which users involved in the transactions represented by the transaction data are uniquely identified. The term “user” is used herein to refer to individuals participating in transactions such as, for example, purchase transactions conducted remotely (e.g., such as transactions conducted between the user and a merchant over the Internet). As used herein, the term “uniquely identified” acknowledges that not every user may be specifically identified—but that a probabilistic distribution of users is produced. In some embodiments, the distribution may be adjusted based on input data provided by a user operating a user device 110 as will be described further below. Applicants have determined that use of the present invention on large transaction data sets results in significant improvements in the unique identification of users. Embodiments allow real-time generation of data sets with a probabilistic distribution that matches a desired confidence level selected by an analyst. As used herein, the term “unique identifier” or “UID” is used to refer to a unique identification of a user within a data set.

The processing system 120 is in communication with one or more databases or datastores, including, for example, one or more sets of input data 130, one or more sets of intermediate data 132 (produced based on initial operations performed on the input data 130 as will be described further below) and one or more sets of user identifier data 134. The user identifier data 134 may be a probabilistic distribution of users in the input data 130 and the distribution may be influenced based on a confidence level or other input data provided by the analyst. As will be described further below, embodiments allow an analyst operating an analyst device 110 to select a confidence level to use to generate the probabilistic distribution. For example, a high degree of confidence (with a high confidence level input) may result in a distribution of user identifiers which requires a high degree of confidence that a user has properly been identified. Such a distribution may be used to produce user identifier data 134 which may be used in applications that require a high degree of confidence of identification of a user such as, for example, credit risk scoring applications, lending applications or the like. A lower degree of confidence may be selected when the user identifier data 134 is to be used for an application such as fraud scoring. Other examples of applications and the probabilistic distribution of user identifier data 134 will be described further herein. In general, however, embodiments allow the selection of a desired confidence level which results in the production of different sets of user identifier data 134 which may be used for different applications.

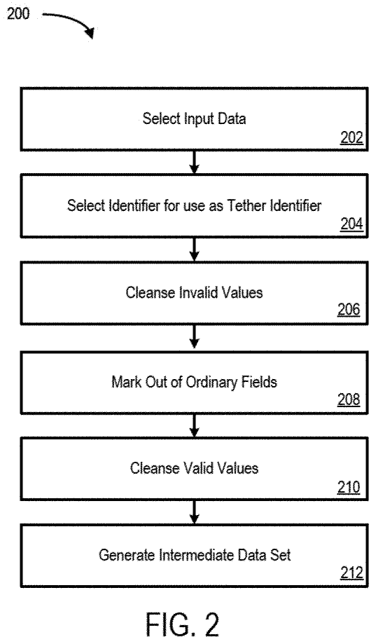

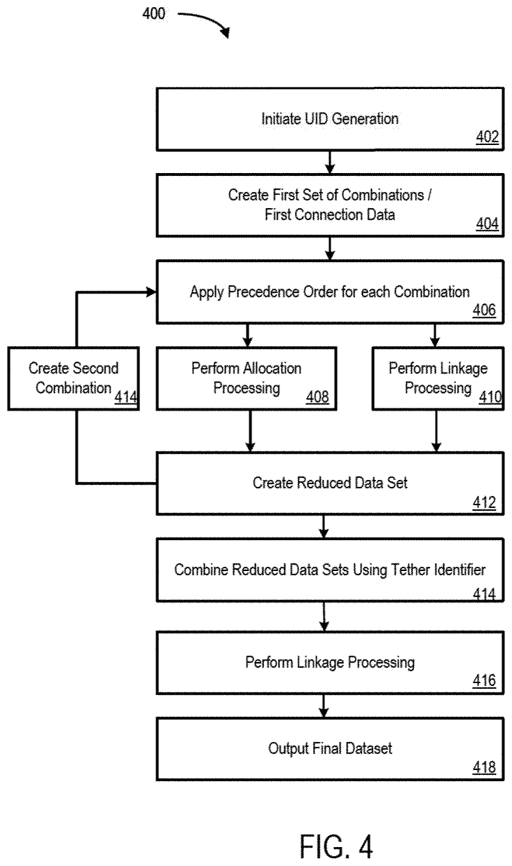

The processing system 120 may be configured to operate as, for example, a Web server, allowing analysts or operators operating analyst devices 110 to interact with one or more applications associated with the processing system 120 to perform processing as described further herein (e.g., such as the processing to perform the methods of FIGS. 2 and 4 described further below). Pursuant to some embodiments, the processing system 120 may operate one or more applications such as a query service application 122, a data cleansing application 124, and a unique identifier (“UID”) generation application 126. Those skilled in the art, upon reading the present disclosure, will appreciate that other applications or configurations of services may be used to perform the processing described herein.

The query service application 122 may be an application that allows the selection of a set of input data 130. For example, the query service application 122 may allow an analyst operating an analyst device 110 to query a data warehouse or other large set of transaction data to select those transactions of interest. As an illustrative example, the data warehouse may include millions of transactions conducted over multiple years. An analyst operating a user device 110 may only wish to perform processing to generate a probabilistic distribution of users associated with transactions conducted in the last year. The query service application 122 may be used to perform such a query and to select a set of input data 130 for further processing.

The data cleansing application 124 may include code and application logic to apply one or more data cleansing rules to the set of input data 130. Applicants have found that proper data cleansing, as described herein, substantially improves the performance of the system of the present invention. Payment transactions, for example, can have a large amount of invalid or useless data. As an example, when payment transactions are processed, a transaction identifier is typically associated with the transaction. Because the transaction typically includes multiple parties (including, e.g., a merchant, a merchant payment processor, an issuer, etc.) there are opportunities for the transaction identifier to be written or stored incorrectly. As an example, it is not uncommon for the transaction identifier to be overwritten or deleted by one of the participants. It is also not uncommon for the transaction identifier to be hard coded to a fixed value by one of the participants. As a result, a set of input data records 130 may include a number of transactions seemingly having duplicate transaction identifiers (e.g., NULL or some overwritten value that is repeated across multiple records). Embodiments use a data cleansing application 124 configured to flag or otherwise handle such unclean data (e.g., which may be stored or available as one or more intermediate data stores 132). Further details of the data cleansing application 124 will be provided further below in conjunction with FIG. 2.

The processing system 120 may also include a UID generation application 126 which is configured to perform processing on an intermediate data set 132 to produce a user identifier data 134 in which UIDs are assigned to the transaction data. In some embodiments, the UID generation application 126 receives one or more inputs (e.g., from an analyst operating analyst device 110) to adjust a confidence level of the UID generation application 126. Further details of the processing of the UID generation application 126 will be provided below in conjunction with FIG. 4.

The analyst device 110 may communicate with the processing system 120 via a network such as a cellular network, the Internet or the like. While only one analyst device 110 is shown in communication with processing system 120, in practical application, a number of users or analysts may interact with the processing system 120 via other analyst devices.

FIG. 2 illustrates a data preparation process 200 that may be performed by the system 100 prior to performance of a UID generation process 400 of FIG. 4. In some embodiments, the process 200 may be performed each time an analyst begins an analysis of a data set. In some embodiments, the process 200 may be performed on a set of input data 130 to produce a clean set of intermediate data 132 for use by analysts to perform multiple iterations of UID generation. In general, the data preparation process 200 is performed on input data 130 including data from a number of transactions involving a number of users. The input data 130 may be a data set resulting from processing of a query service 122 (e.g., to select a desired range of transaction data). Process 200 begins at 202 where the input data set is received (e.g., as a result of processing of the query service 122). Processing continues at 204 where a tether identifier is selected. In some embodiments, different data elements may be used as a tether identifier for use in generating UIDs, including for example, phone numbers, email addresses, payment card identifiers, address data, IP addresses, names, and cardholder names. Applicants have found that phone numbers, email addresses and payment card identifiers provide a number of desirable benefits as tether identifiers, although the other data elements have beneficial uses. For example, a user's name or a cardholder name (the name on a payment card) are non-contact types of information that may be used for more accuracy in some embodiments. Phone numbers, email addresses and mailing addresses are examples of types of contact information. For the purposes of describing features of some embodiments, the use of a phone number as a tether identifier will be described herein. The term “tether identifier” is used to refer to information that is used to link or associate different pieces of information with each other during processing pursuant to the present invention.

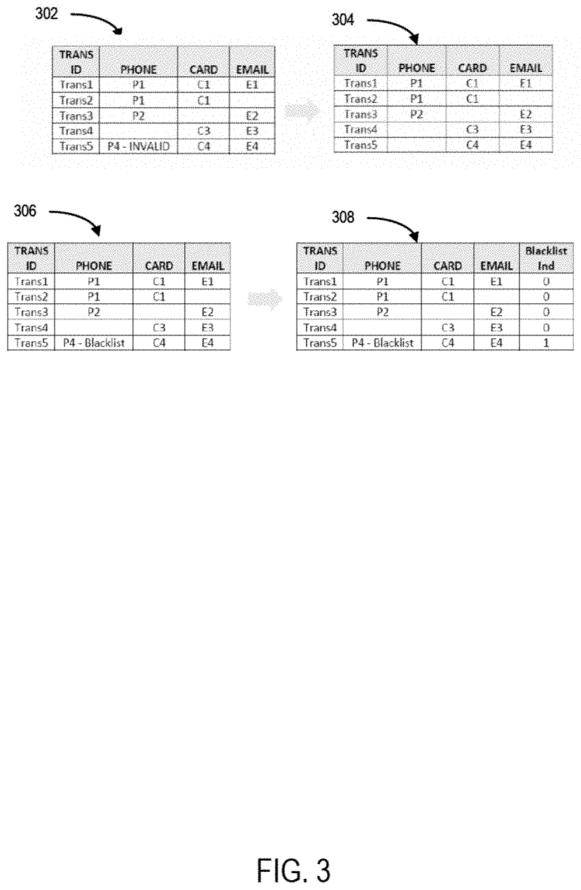

Process 200 continues at 206 where the processing system 120 is operated to perform an initial data cleansing (e.g., by the operation of data cleansing application 124) to cleanse invalid values. As discussed briefly above, transaction data can include a number of inconsistent or wrong data items. Transaction identifiers may be recorded improperly or not recorded at all. This may affect a number of data fields in a transaction (including the phone number, email address, etc.). Processing at 206 may include processing to apply one or more rules to standardize junk or invalid field values. For example, a rule may be applied to replace clearly invalid phone numbers (e.g., phone numbers shown as “9999999999”) with a NULL. As another example, a rule may be applied to replace blank fields with a NULL. Pursuant to some embodiments, a number of rules may be applied at 206 and those rules may vary based on the input data set (e.g., as an analyst identifies different invalid data in the data set). By replacing invalid data with a consistent value (e.g., NULL), embodiments can process the invalid fields more consistently. An example of a processing to identify and modify an invalid field in an input data set is illustrated in the tables 302 and 304 of FIG. 3 where the table 302 shows a portion of an input data set with an invalid phone field (P4) in the record for Trans5 and the table 304 shows the resulting portion of the intermediate data set where the invalid phone field is replaced with a NULL or blank field.

Processing continues at 208 where the processing system 120 is operated (e.g., using the data cleansing application 124) to mark out of the ordinary field values. This may be performed, for example, by setting a flag or other indicator. As an example, an input data set may include a number of transactions that use an email address or a domain nameknown to be associated with a high degree of fraud or otherwise not a valid identifier of a user (but which is actually a valid email address). Such otherwise valid data may be flagged. These flags will be used in the UID generation process described further below in conjunction with FIG. 4. As another example, a phone number, email address or payment card may be associated with a large number of unsuccessful transactions in an input data set. Those fields may be marked with a flag. In some embodiments, these flags may be set by applying one or more rules to the input data set so that the flags may be automatically applied to the input data set. In general, flags may be set on fields that may include valid data but for which the data is out of the ordinary. The flags set for invalid data may be applied using a blacklist approach (where a list or set of invalid data—a blacklist—is stored and applied by the data cleansing application 124). The use of a blacklist makes the process of maintaining and updating the invalid data flags more efficient.

A portion of an input data set is illustrated in the table 306 of FIG. 3. Table 306 includes a phone field that matches a phone number on a blacklist. As shown in table 308 (which illustrates a portion of an intermediate data set), the transaction record including the blacklisted phone number has been appended with a new field for a flag indicating that the transaction record has a field that has blacklisted data in it. This flag may be used during UID generation processing as will be further described below in conjunction with FIG. 4.

Processing continues at 210 where the processing system 120 is operated (e.g., using the data cleansing application 124) to cleanse valid values (e.g., to make valid data more consistent). This may include, for example, formatting data to make it consistent, etc. Examples of processing at 210 include identifying and removing duplicate transactions and identifying and removing test transactions. The cleansing of 210 may be performed using one or more rules that may be updated or modified based on attributes or characteristics of the input data set 130. Processing continues at 212 where the processing system 120 is operated to generate an intermediate data set 132. This intermediate data set has data that has been cleansed and flagged and is, for example, the data set used as the input to the UID generation process 400 of FIG. 4.

Processing may now include executing or interacting with the UID generation application 126 of the processing system 120 to operate on the intermediate data set 132 to generate a user identifier data 134 having a desired probabilistic distribution of users identified by UIDs. A process such as the UID generation process 400 of FIG. 4 may be performed. For convenience and ease of exposition, the UID generation process 400 will be described assuming that analyst device 110 will use the phone number field of the data set as the tether identifier. Those skilled in the art, upon reading the present disclosure, will appreciate that similar processing may be performed if other fields are selected as the tether identifier. Further, the following description uses an example in which the transaction data set includes transactions that include one or more of a phone number, an email address and a payment card identifier (e.g., such as a primary account number of a credit or debit card). Not every transaction record will include each of these fields.

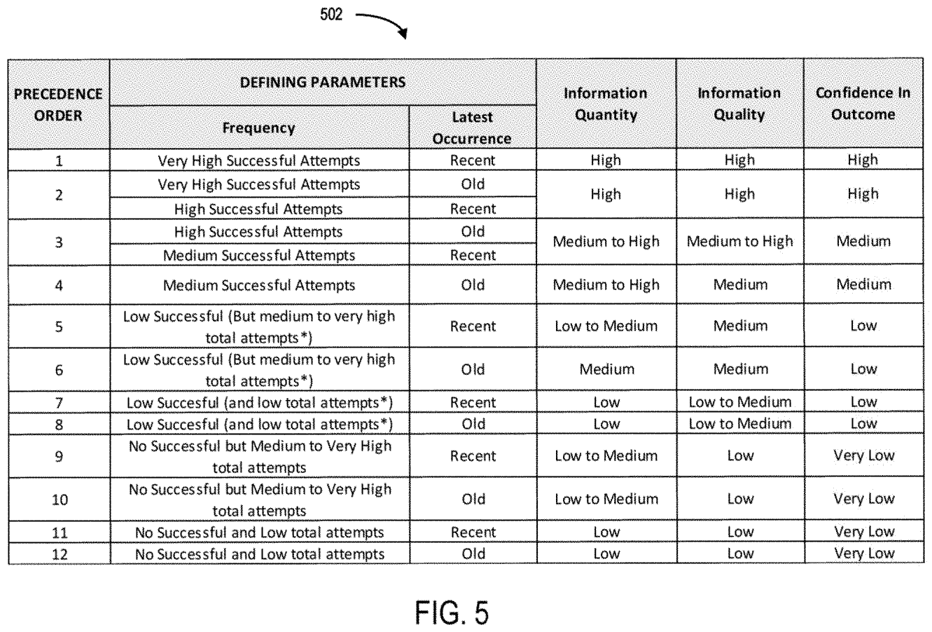

Further, pursuant to some embodiments, a set of one or more precedence rules are also provided. An example of a set of precedence rules 502 is shown in FIG. 5. The set of precedence rules 502 is an example, and different rules may be used for different types of data sets or based on different needs. The precedence rules 502 shown in FIG. 5, a number of rules are shown in order from 1 to 12, with 1 being the highest precedence rule. The rules will be referred to herein by their precedence order. For example, the rule in precedence order 1 is satisfied if, for a given identifier (such as, for example, a phone number), there are a large amount of recent successful transactions. In the table of FIG. 5, the amount of transactions is expressed as a frequency and includes information about the volume (“very high” to “low”), and the outcome (“successful” or “not successful”). The recency may be varied for different purposes, but in general, a “recent” successful transaction may be one that was authorized in the past twelve (12) months. That is, to satisfy the first precedence rule, there must be a number of successful transactions within the last year. In the illustrative example of FIG. 5, the second precedence rule requires either a high frequency of recent successful transactions or a very high frequency of successful transactions that are older (e.g., such as transactions that occurred over twelve (12) months ago). The rules in the example precedence rules 502 are selected to provide varying information quantity and quality and to provide different possible case inferences. For example, for a phone number that satisfies the first precedence rule, it may be inferred that the phone number is associated with a primary user. Satisfying the second precedence rule provides information that suggests that the identifier (e.g., the phone number) is closely related with the primary user (and may involve a user who changed their phone number in the past year). In the illustrative precedence rules 502, each rule may have a corresponding rule that determines how the UID should be treated if the rule is satisfied. For example, for a phone number that satisfies the first precedence rule, the phone number should be linked under one (1) UID.

While continuing to refer to FIG. 5, a brief description of how the precedence rules work in conjunction with the present invention. For example, as discussed herein, precedence rules are used to cut off or select certain data while performing processing of the present invention. As an illustrative example, assume that phone P1 occurs with card C1 in three successful transactions within the last year (a “Recent” period). In the precedence rules of FIG. 5, this combination is marked as precedence level 3. Assume that phone P2 occurs with card C1 in two successful transactions within a period two years ago (an “Old” period). This combination will be marked as precedence level 4. During linkage procesing (as described in conjunction with FIG. 4), if precedence level 3 is selected as the cutoff for linking user identifiers, P1 and P2 will be assigned different UID values. Further, card C1 will be allocated to the UID for P1 (because of the higher precedence). If precedence level 4 is selected as the cutoff for linking user identifiers, P1 and P2 and C1 will all be assigned the same UID. The selection of the precedence level for linkage processing has a large impact on the outcome of the linkage processing.

Referring now to FIG. 4, the UID generation process 400 will now be described (with reference to the precedence rules 502 of FIG. 5). The UID generation process 400 begins at 402 where an analyst interacting with an analyst device 110 or some other actor initiates the process 400 (e.g., by interacting with a user interface, application programming interface “API” or taking some other action). In general, the initiation 402 may occur after a set of input data has been selected and after the set of input data has been cleansed as described in conjunction with FIG. 2 (e.g., starting from an intermediate data set as described above).

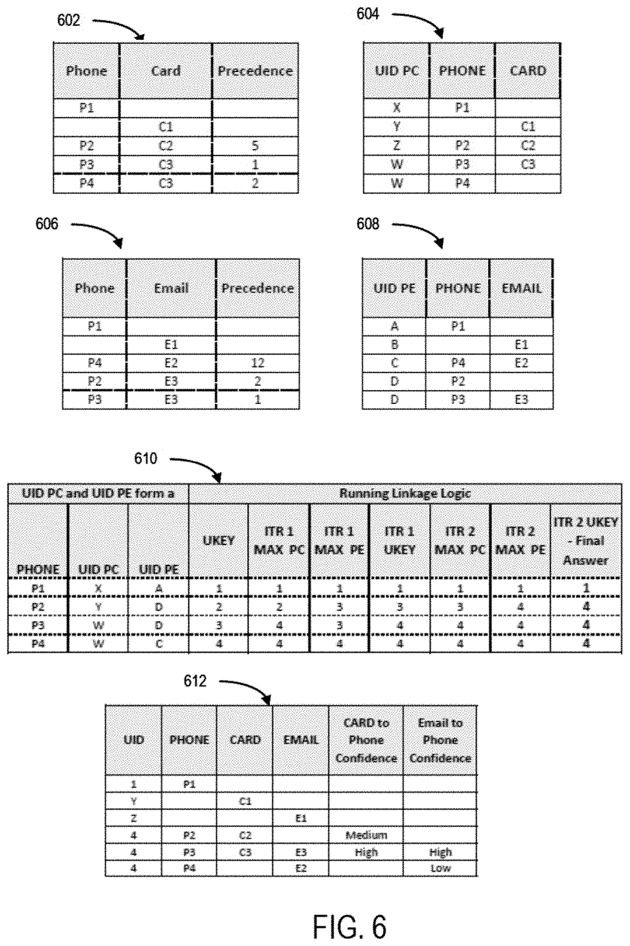

Processing continues at 404 where a first set of combinations (or a first set of connection data) is made. For example, in the illustrative example where the phone data field is selected for use as the tether identifier, processing at 404 includes processing to create phone/card combinations. For example, referring to FIG. 6, a subset of transactions is shown as table 602 where phone/card combinations have been made. In table 602, the phone number identified as “P1” has no card associated with it. In table 604, P1 has been assigned a UID of “X”. Card “C1” has no phone associated with it and has been assigned a UID of “Y” in table 604. The phone identified as “P2” has been used with card “C2” and is assigned UID of “Z”. The phones “P3” and “P4” both were identified as having been used with card “C3” and both are assigned a UID of “W”. Processing continues at 406 where the precedence order is assigned (by reference to the preference rules 502 of FIG. 5) for each transaction. That is, the intermediate data set is analyzed for each phone in the combination table 602 to determine which precedence order (if any) should be assigned to each transaction. A precedence level of “5” is associated with the association of “P2” and “C2” indicating that there is a medium level of confidence that the card “C2” belongs to the phone “P2”. Based on analysis of the transaction records, a determination is made that the precedence level of phone “P3” is higher than that of “P4”. That is, there is a higher confidence level that the card “C3” should be associated with the phone “P3” and, as a result, the card “C3” is associated with the phone “P3” as shown in table 604. In this way, the precedence order associated with individual combinations can be used to determine which combination has a greater likelihood of being correct (e.g., even though both P3 and P4 were associated with card C3, it is more likely that the P3 is the correct phone to associate with card C3).

Process 400 continues at 408 where allocation processing is performed to assign one card to each phone number. This allocation processing may include assigning ranks between combinations in case there is a precedence tie and eventually creating an updated dataset where each card has a single phone number as shown in table 604 of FIG. 6. As discussed above, even though phones P3 and P4 were both used with card C3, the card C3 is allocated to the phone P3 due to the higher precedence. Processing also continues (either in parallel or sequentially) at 410 where linkage processing is performed. Pursuant to some embodiments, the linkage processing at 410 includes linking phone numbers using a UID based on occurrence within cards. Each phone number is assigned a single UID as shown in table 604. Processing continues at 412 where a reduced data set is produced where each card has only one phone number (or no phone number) and each phone number has a single UID.

Processing continues at 414 where a second combination is created using the email address. That is, email addresses are used to create a further reduced data set of combinations (using the tether identifier) of phone number and email addresses as shown in FIG. 6, tables 606 and 608. Processing continues at 416 where the reduced data sets are combined by creating combination data for the UIDs of phone number and card and phone number and email address. Pursuant to some embodiments, each phone number will have one UID for each combination (e.g., a UID for the phone/card combination and a UID for the phone/email combination) as shown on the left side of table 610 of FIG. 6 (e.g., which is a result of the combination of table 604 with table 608).

Processing continues at 416 where linkage processing is performed. Pursuant to some embodiments, the linkage processing is performed in an iterative process to combine the two UIDs (the UID for the phone/card combination and the UID for the phone/email combination) into a single UID as well as to allocate transactions without a tether identifier field (e.g., in the example where the phone number is used as the tether identifier, processing at 416 includes allocating transactions where no phone number is available). Pursuant to some embodiments, processing at 416 may include different processing for individual records based on information in those records. A first processing may be performed when only a card is present in the transaction record. If that card number can be matched to the same card number in a different transaction, the card number will be allocated to the matched card (e.g., to create an association to the tether identifier in that matched record). If that card number cannot be matched to a different transaction, a pseudo or temporary phone number may be allocated to the record.

A second processing may be performed when only an email address is present in the transaction record. If the email address can be matched to the same email address in a different transaction, the email address is so allocated. If the email address cannot be matched with a different transaction, a pseudo or temporary phone number may be allocated to the record. A third processing may be performed when both a card number and an email address are present in the record (but no tether identifier or phone number is present in that record). If the card number matches another transaction, but the email doesn't, the record is allocated to the user where the card number is matched, and the new email/phone combination is usable in the next iteration of step 416. If the email matches another transaction but the card number does not, the record is allocated to the user where the email is matched, and the new card/phone combination is usable in the next iteration of step 416. If the card number and the email in the record are matched to another record which has the same phone number, then the record (and the card number and the email) are allocated to the user associated with the record in which the card and the email were both matched. Finally, if the card in the record is matched to a phone but the email is matched to a different phone number, the record is allocated to the record or user where the card matched (as, in some embodiments, the card number is given priority over email addresses). The email/phone combination is used in the next iteration of step 416. This processing at 416 repeats until a final answer is reached (e.g., where the iterative processing described above reaches a final conclusion and does not result in any further changes).

Further details of processing at 414 and 416 will now be described by reference to table 610 of FIG. 6. The linkage processing shown in table 610 may be performed on subsets of data (for example, subsets that may be selected based on precedence levels). For each such subset of data, a serial numeric value is assigned to each combination of UID PC and UID PE (shown as the column UKEY). For example, the UKEY of “1” is assigned to the combination of UID PC “X” and UID PE “A”. A first iteration is then performed where the max value of UKEY for each value of UID PC is selected and merged back to the data (shown as ITR1 MAX PC). For example, the MAX PC of “W” in the first iteration is “4”. Then, the max value of UKEY for each value of UID PE is selected and merged back to the data (shown as ITR1 MAX PE). For example, the MAX PE of “D” in the first iteration is “3”. Processing continues when the higher value of the two columns (“ITR1 MAX PC” and “ITR1 MAX PE”) is selected and stored in column “ITR1 UKEY”. For example, the ITR1 UKEY for phone “P3” is selected to be “4”.

Processing continues as the values of column “ITR1 UKEY” are compared to the values of column “UKEY”. If there was a change in at least one value, a second iteration is run. In the example table 610, there have been changes in two values and therefore a second iteration is performed. The second iteration may be performed in a similar way as the first iteration. First, the max value of “ITR1 UKEY” is selected for each value of “UID PC” and is merged back into the data (and stored as “ITR2 MAX PC”). Then, the max value of “ITR1 UKEY” is selected for each value of “UID PE” and is merged back into the data (and stored as “ITR2 MAX PE”). Processing continues as the higher value of the two columns (ITR2 MAX PC and ITR2 MAX PE) are selected for each row and stored as “ITR2 UKEY”. Again, if there was a change in at least one value, a further iteration may be performed until no further changes in values are observed.

Upon completion of the linkage processing, process 400 continues at 418 where a final dataset is produced (and, for example, stored as user identifier data 134 accessible to the system 120 of FIG. 1). This output data may be used by analysts or others to perform processing which requires some identification of users. For example, the output dataset may be used for fraud processing, for loan or new account underwriting, or the like. The final dataset may include a set of UIDs with any associated fields (phone, card, email in the current example) and confidence levels. An illustrative example of a portion of such a final dataset is shown as table 612 of FIG. 6.

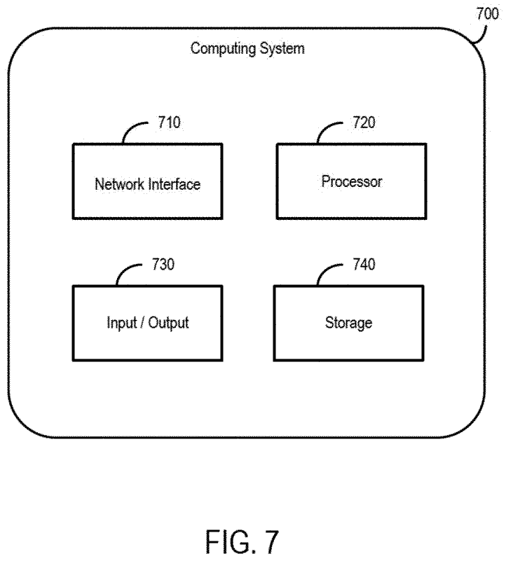

FIG. 7 illustrates a computing system 700 that may be used in any of the methods and processes described herein, in accordance with an example embodiment. For example, the computing system 700 may be a database node, a server, a cloud platform, or the like. In some embodiments, the computing system 700 may be distributed across multiple computing devices such as multiple database nodes. Referring to FIG. 7, the computing system 700 includes a network interface 710, a processor 720, an input/output 730, and a storage device 740 such as an in-memory storage, and the like. Although not shown in FIG. 7, the computing system 700 may also include or be electronically connected to other components such as a display, an input unit(s), a receiver, a transmitter, a persistent disk, and the like. The processor 720 may control the other components of the computing system 700.

The network interface 710 may transmit and receive data over a network such as the Internet, a private network, a public network, an enterprise network, and the like. The network interface 710 may be a wireless interface, a wired interface, or a combination thereof. The processor 720 may include one or more processing devices each including one or more processing cores. In some examples, the processor 720 is a multicore processor or a plurality of multicore processors. Also, the processor 720 may be fixed or it may be reconfigurable. The input/output 730 may include an interface, a port, a cable, a bus, a board, a wire, and the like, for inputting and outputting data to and from the computing system 700. For example, data may be output to an embedded display of the computing system 700, an externally connected display, a display connected to the cloud, another device, and the like. The network interface 710, the input/output 730, the storage 740, or a combination thereof, may interact with applications executing on other devices.

The storage device 740 is not limited to a particular storage device and may include any known memory device such as RAM, ROM, hard disk, and the like, and may or may not be included within a database system, a cloud environment, a web server, or the like. The storage 740 may store software modules or other instructions which can be executed by the processor 720 to perform the methods shown in FIGS. 2 and 4. According to various embodiments, the storage 740 may include a data store that stores data in one or more formats such as a multidimensional data model, a plurality of tables, partitions and sub-partitions, and the like. The storage 740 may be used to store database records, items, entries, and the like.

According to various embodiments, the processor 720 may be configured to perform query processing by operating a query service 122, perform data cleansing using a data cleansing service 124, perform UID generation processing by operating a UID generation service 126, or other processing as will be apparent to those skilled in the art upon reading the present disclosure. In general, the processor 720 may be configured to perform any of the functions outlined herein. The storage 740 may be configured to store the generated user identifier data in a user identifier data 134.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A system, comprising:
a communication device to receive a request to create unique identifiers (“UIDs”) to uniquely identify a plurality of users associated with a plurality of transactions in an input data set;
a processor coupled to the communication device; and
a computer storage device in communication with the processor and storing instructions adapted to be executed by the processor to:
receive the input data set, the input data set including a plurality of transaction records, each transaction record including a number of fields;
receive a selection of one of the number of fields as a tether identifier;
modify the input data set to produce an intermediate data set, the intermediate data set having one or more invalid values modified; and
operate on the intermediate data set to create a final data set in which a UID is assigned to each set of transactions that can be linked to a user.

2. The system of claim 1, wherein the fields include at least one of an email address field, a phone number field, and a payment identifier field.

3. The system of claim 1, wherein the instructions adapted to be executed by the processor to modify the input data set to produce an intermediate data set further includes instructions adapted to be executed by the processor to:
apply a set of precedence rules to each transaction record and assigning a precedence value to each transaction record.

4. The system of claim 4, wherein applying the set of precedence rules includes analyzing occurrences of the tether identifier throughout the input data set to determine the precedence value for the transaction record.

5. The system of claim 4, wherein the set of precedence rules includes a rule specifying (i) a count of successful recent transactions involving the tether identifier, (ii) a count of successful old transactions involving the tether identifier, (iii) an indication of more than one recent failed transactions, and (iv) an indication of more than one old failed transactions.

6. The system of claim 5, wherein a recent transaction is one within a year and an old transaction is one over a year old.

7. The system of claim 1, wherein modifying the input data set further includes flagging one or more records having out of the ordinary values.

8. The system of claim 7, wherein an out of the ordinary value is a value that matches a blacklist of values and wherein flagging one or more records includes indicating that the record includes a value matching the blacklist.

9. The system of claim 2, wherein the phone field is selected as the tether identifier, further comprising instructions adapted to be executed by the processor to:
create a first set of data from the intermediate data set in which data from the phone number fields are matched with data from the payment identifier fields;
create a second set of data from the intermediate data set in which data from the phone number fields are matched with data from the email fields.

10. The system of claim 9, reducing the first and second set of data by removing data having a precedence lower than a selected precedence level.

11. The system of claim 10, further comprising instructions adapted to be executed by the processor to:
iteratively combine data from the reduced first and second set of data to create the final data set.

12. The system of claim 4, further comprising instructions adapted to be executed by the processor to:
select a precedence level as a cutoff; and
assign the UID using precedence rules above the cutoff.

13. A method, comprising:
receiving a request to uniquely identify data associated with a plurality of users in an input data set, the input data set including a plurality of transaction records, each transaction record including at least a first identifier field, a second identifier field and a third identifier field;
receiving a selection of one of the identifiers as a tether identifier;
creating a first set of data in which data from the first identifier fields are matched with data from the third identifier fields;
creating a second set of data in which data from the first identifier fields are matched with data from the second identifier fields;
reducing the first and second set of data by removing data having a precedence lower than a selected precedence level; and
generating a final data set in which a unique identifier is assigned to each set of transactions that can be linked to a user.

14. The method of claim 13, further comprising:
modifying the input data set to produce an intermediate data set, the intermediate data set having one or more invalid values modified.

15. The method of claim 14, wherein modifying the input data set further includes flagging one or more records having out of the ordinary values.

16. The method of claim 15, wherein an out of the ordinary value is a value that matches a blacklist of values and wherein flagging one or more records includes indicating that the record includes a value matching the blacklist.

17. The method of claim 13 wherein the selected precedence level includes a rule specifying (i) a count of transactions involving the tether identifier, (ii) a count of successful transactions, (iii) a count of failed transactions, and (iv) an indication of the recency of the transactions.

18. The method of claim 13, wherein the first identifier fields are phone number fields, the second identifier fields are email fields and the third identifier fields are payment card fields.

19. The method of claim 13, wherein the unique identifier is assigned based on a set of precedence rules having a precedence level greater than the selected precedence level.

20. The method of claim 19, wherein the selected precedence level is selected based on a desired confidence level of a relationship between the input data set and the user.
